(19) United States
(12) Patent Application Publication
(10) Pub. No.: US 2015/0114429 A1
(43) Pub. Date: Apr. 30, 2015

(54) AQUEOUS CLEAN SOLUTION WITH LOW COPPER ETCH RATE FOR ORGANIC RESIDUE REMOVAL IMPROVEMENT

(71) Applicants: Shrane Ning Jenq, Yonghe City (TW); Karl E. Boggs, Hopewell Junction, NY (US); Jun Liu, Brookfield, CT (US); Nicole Thomas, Bolton, MA (US)

(72) Inventors: Shrane Ning Jenq, Yonghe City (TW); Karl E. Boggs, Hopewell Junction, NY (US); Jun Liu, Brookfield, CT (US); Nicole Thomas, Bolton, MA (US)

(73) Assignees: ATMI Taiwan Co., Ltd., Hsin-chu (TW); Advanced Technology Materials, Inc., Danbury, CT (US)

(21) Appl. No.: 14/401,739

(22) PCT Filed: May 17, 2013
(86) PCT No.: PCT/US2013/041634

§ 371 Date: Nov. 17, 2014

Related U.S. Application Data
(60) Provisional application No. 61/695,548, filed on Aug. 31, 2012.
(60) Provisional application No. 61/648,937, filed on May 18, 2012.

(51) Int. Cl. C11D 11/00; C11D 7/32; C25D 5/48

(52) U.S. Cl. CPC C11D 11/0047; C25D 5/48; C11D 7/3209; C11D 7/3218; C11D 7/3281
USPC 134/2; 205/122; 510/175

(57) ABSTRACT

A cleaning composition and process for cleaning post-chemical mechanical polishing (CMP) residue and contaminants from a microelectronic device having said residue and contaminants thereon. The cleaning compositions include at least one quaternary base, at least one amine, at least one corrosion inhibitor, and at least one solvent. The composition achieves highly efficacious cleaning of the post-CMP residue and contaminant material from the surface of the microelectronic device while being compatible with barrier layers.

### FIELD

The present invention relates generally to compositions for substantially and efficiently cleaning residue and/or contaminants from microelectronic devices having same thereon, wherein the compositions efficaciously remove said residue and contaminants, minimize water mark defects on ultra low-k materials and have increased compatibility with copper, ruthenium, cobalt, manganese, and low-k dielectric materials.

### DESCRIPTION OF THE RELATED ART

It is well known that integrated circuit (IC) manufacturers have replaced aluminum and aluminum alloys with copper for advanced microelectronic applications because copper has a higher conductivity that translates to significant improvement in the interconnect performance. In addition, copper-based interconnects offer better electromigration resistance than aluminum, thereby improving the interconnect reliability. That said, the implementation of copper faces certain challenges. For example, the adhesion of copper (Cu) to silicon dioxide (SiO₂) and to other dielectric materials is generally poor. Poor adhesion results in the delamination of Cu from adjoining films during the manufacturing process. Also, Cu ions readily diffuse into SiO₂ under electrical bias, and increase the dielectric electrical leakage between Cu lines even at very low Cu concentrations within the dielectric. In addition, if copper diffuses into the underlying silicon where the active devices are located, device performance can be degraded.

The problem of the high diffusivity of copper in silicon dioxide (SiO₂), and in other inter-metal dielectrics (IMDs)/interlevel dielectrics (ILDs), remains of great concern. To deal with this issue, an integrated circuit substrate must be coated with a suitable barrier layer that encapsulates copper and blocks diffusion of copper atoms. The barrier layer, comprising both conductive and non-conductive materials, is typically formed over a patterned dielectric layer and prior to deposition of copper. It is known that the thickness of the barrier, if too great, can create problems with subsequent copper coatings and filling of ultra-fine features, e.g., a sub-100 nm diameter via. If the barrier inside a sub-100 nm diameter via is too thick, it reduces the available volume of copper within the features leading to increased resistance of the via that could offset the advantage offered by the use of copper. Typical materials for the barrier layer include tantalum (Ta), tantalum nitride (TaNₓ), titanium (Ti), titanium nitride (TiN), ruthenium (Ru), cobalt (Co), manganese (Mn), and the like.

Electrolytic deposition methods are used to fill the conductive pathways with copper. Before inlaying the line paths with electrolytic deposition of copper, a conductive surface coating must be applied on top of the barrier layer because conventional barrier materials exhibit high electrical resistivity and hence, cannot transport current during electrolytic copper plating. Typically, a PVD copper seed layer is deposited on the barrier layer. Next, a much thicker layer of copper is deposited on the seed layer by electroplating. After deposition of the copper is completed, the copper is planarized, generally by chemical mechanical planarization (CMP) down to the dielectric in preparation for further processing.

The continuing trend towards smaller features size in ICs requires that the thickness of the barrier layer be reduced in order to minimize the contribution of electrical resistance of conventional barrier layers. Thus, the replacement of conventional barrier layers with newer materials that have reduced electrical resistance is appealing. This is because it would further improve the conductivity in the patterns, i.e., lines and vias, thereby increasing the speed of signal propagation compared to interconnect structures using conventional barrier layers. Furthermore, electrolytic plating of copper directly onto conductive barrier materials precludes the use of a separate copper seed layer, thereby simplifying the overall process. Amongst various candidate materials that could serve as directly plateable diffusion barriers, the use of ruthenium (Ru), cobalt (Co), manganese (Mn), molybdenum (Mo), rhenium (Rh), and alloys thereof has been suggested.

The foregoing processing operations, involving wafer substrate surface preparation, deposition, plating, etching and chemical mechanical polishing, variously require cleaning operations to ensure that the microelectronic device product is free of contaminants that would otherwise deleteriously affect the function of the product, or even render it useless for its intended function. Often, particles of these contaminants are smaller than 0.3 μm.

One particular issue in this respect is the residues that are left on the microelectronic device substrate following CMP processing. Such residues include CMP material and corrosion inhibitor compounds such as benzotriazole (BTA). If not removed, these residues can cause damage to copper lines or severely roughen the copper metallization, as well as cause poor adhesion of post-CMP applied layers on the device substrate. Severe roughening of copper metallization is particularly problematic, since overly rough copper can cause poor electrical performance of the product microelectronic device. Towards that end, post-CMP removal compositions have been developed to remove the post-CMP residue and contaminants.

As new barrier layers are introduced, post-CMP removal compositions have to be developed to ensure that the compositions do not deleteriously affect the copper, low-k dielectric and said new barrier layer materials while still removing the post-CMP residue and contaminants. Moreover, the post-CMP removal compositions should not leave behind water marks on the ultra low-k dielectric materials. Accordingly, it is an object of the present disclosure to identify novel post-CMP compositions that will substantially and efficiently remove post-CMP residue and contaminants without deleteriously affecting the microelectronic device.

### SUMMARY

The present invention generally relates to a composition and process for cleaning residue and/or contaminants from microelectronic devices having said residue and contaminants thereon. Advantageously, the compositions minimize water mark defects on ultra low-k materials as well as have increased compatibility with copper, ruthenium, cobalt, manganese, and low-k dielectric materials.

In one aspect,

Other aspects, features and advantages will be more fully apparent from the ensuing disclosure and appended claims.

### DETAILED DESCRIPTION, AND PREFERRED EMBODIMENTS THEREOF

The present invention generally relates to a composition and process for cleaning residue and/or contaminants from microelectronic devices having said residue and contaminants thereon. The compositions minimize water mark defects on ultra low-k materials as well as have increased compatibility with copper, cobalt, ruthenium, manganese, and low-k dielectric materials. The compositions can also be used for the removal of post-etch or post-ash residue.

For ease of reference, “microelectronic device” corresponds to semiconductor substrates, flat panel displays, phase change memory devices, solar panels and other products including solar substrates, photovoltaics, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

As used herein, “residue” corresponds to particles generated during the manufacture of a microelectronic device including, but not limited to, plasma etching, ashing, chemical mechanical polishing (CMP), wet etching, and combinations thereof.

As used herein, “contaminants” correspond to chemicals present in the CMP slurry, reaction by-products of the polishing slurry, chemicals present in the wet etching composition, reaction by reaction byproducts of the wet etching composition, and any other materials that are the by-products of the CMP process, the wet etching, the plasma etching or the plasma ashing process.

As used herein, “post-CMP residue” corresponds to particles from the polishing slurry, e.g., silica-containing particles, chemicals present in the slurry, reaction by-products of the polishing slurry, carbon-rich particles, polishing pad particles, brush deloading particles, equipment materials of construction particles, copper, copper oxides, organic residues, barrier layer residues, and any other materials that are the by-products of the CMP process.

As defined herein, “low-k dielectric material” corresponds to any material used as a dielectric material in a layered microelectronic device, wherein the material has a dielectric constant less than about 3.5. Preferably, the low-k dielectric materials include low-polarity materials such as silicon-containing organic polymers, silicon-containing hybrid organic/inorganic materials, organosilicate glass (OSG), TEOS, fluorinated silicate glass (FSG), silicon dioxide, carbon-doped oxide (CDO) glass, CORAL™ from Novellus Systems, Inc., BLACK DIAMOND™ from Applied Materials, Inc., SiLK™ from Dow Corning, Inc., and NANOGLASS™ of Nanopore, Inc, and the like. It is to be appreciated that the low-k dielectric materials may have varying densities and varying porosities. “Ultra low-k dielectrics” have dielectric constants of approximately 2.6 or below.

As defined herein, the term “barrier material” corresponds to any material used in the art to seal the metal lines, e.g., copper interconnects, to minimize the diffusion of said metal, e.g., copper, into the dielectric material. Preferred barrier layer materials include tantalum, titanium, ruthenium, hafnium, ruthenium, cobalt, manganese, molybdenum, rhenium, their nitrides and silicides, and alloys thereof. It should be appreciated that the barrier layer can comprise the same material or be bi-layer (e.g., a seed layer is deposited followed by the deposition of a second barrier layer material). Preferably, for the barrier material comprises cobalt, manganese, and ruthenium or nitrides thereof.

As defined herein, “post-etch residue” corresponds to material remaining following gas-phase plasma etching processes, e.g., BEOL dual damascene processing, or wet etching processes. The post-etch residue may be organic, organometallic, organosilicic, or inorganic in nature, for example, silicon-containing material, carbon-based organic material, and etch gas residue such as oxygen and fluorine.

As defined herein, “post-ash residue,” as used herein, corresponds to material remaining following oxidative or reductive plasma ashing to remove hardened photoresist and/or bottom anti-reflective coating (BARC) materials. The post-ash residue may be organic, organometallic, organosilicic, or inorganic in nature.

“Substantially devoid” is defined herein as less than 2 wt. %, preferably less than 1 wt. %, more preferably less than 0.5 wt. %, even more preferably less than 0.1 wt. %, and most preferably 0 wt %.

As used herein, “about” is intended to correspond to ±5% of the stated value.

As defined herein, “reaction or degradation products” include, but are not limited to, product(s) or byproduct(s) formed as a result of catalysis at a surface, oxidation, reduction, reactions with the compositional components, or that otherwise polymerize; product(s) or byproduct(s) formed formed as a result of a change(s) or transformation(s) in which a substance or material (e.g., molecules, compounds, etc.) combines with other substances or materials, interchanges constituents with other substances or materials, decomposes, rearranges, or is otherwise chemically and/or physically altered, including intermediate product(s) or byproduct(s) of any of the foregoing or any combination of the foregoing reaction(s), change(s) and/or transformation(s). It should be appreciated that the reaction or degradation products may have a larger or smaller molar mass than the original reactant.

As defined herein, “purines and purine-derivatives” include: ribosylpurines such as N-ribosylpurine, adenosine, guanosine, 2-aminopurine riboside, 2-methoxyadenosine, and methylated or deoxy derivatives thereof, such as N-methyladenosine (C₁₁H₁₅N₅O₄), N,N-dimethyladenosine (C₁₂H₁₇N₅O₄), trimethylated adenosine (C₁₃H₁₉N₅O₄), trimethyl N-methyladenosine (C₁₄H₂₁N₅O₄), C-4′-methyladenosine, and 3-deoxyadenosine; degradation products of adenosine and adenosine derivatives including, but not limited to, adenine (C₅H₅N₅), methylated adenine (e.g., N-methyl-7H-purin-6-amine, C₆H₇N₅), dimethylated adenine (e.g., N,N-dimethyl-7H-purin-6-amine, C₇H₉N₅), N4,N4-dimethylpyrimidine-4,5,6-triamine (C₆H₁₁N₅), 4,5,6-triaminopyrimidine, allantoin (C₄H₆N₄O₃), hydroxylated C—O—O—C dimers ((C₅H₄N₅O₂)₂), C—C bridged dimers ((C₅H₄N₅)₂ or (C₅H₄N₅O)₂), ribose (C₅H₁₀O₅), methylated ribose (e.g., 5-(methoxymethyl)tetrahydrofuran-2,3,4-triol, C₆H₁₂O₅), tetramethylated ribose (e.g., 2,3,4-trimethoxy-5-(methoxymethyl)tetrahydrofuran, C₉H₁₈O₅), and other ribose derivatives such as methylated hydrolyzed diribose compounds; purine-saccharide complexes including, but not limited to, xylose, glucose, etc.; and other purine compounds such as purine, guanine, hypoxanthine, xanthine, theobromine, caffeine, uric acid, and isoguanine, and methylated or deoxy derivatives thereof.

As used herein, “suitability” for cleaning residue and contaminants from a microelectronic device having said residue and contaminants thereon corresponds to at least partial removal of said residue/contaminants from the microelectronic device. Cleaning efficacy is rated by the reduction of objects on the microelectronic device. For example, pre- and post-cleaning analysis may be carried out using an atomic force microscope. The particles on the sample may be registered as a range of pixels. A histogram (e.g., a Sigma Scan Pro) may be applied to filter the pixels in a certain intensity, e.g., 231-235, and the number of particles counted. The particle reduction may be calculated using:

$$Cleaning Efficacy = \frac{( \begin{matrix}Number of PreClean Objects - \\ Number of PostClean Objects\end{matrix} )}{Number of PreClean Objects} \times 100$$

Notably, the method of determination of cleaning efficacy is provided for example only and is not intended to be limited to same. Alternatively, the cleaning efficacy may be considered as a percentage of the total surface that is covered by particulate matter. For example, AFM's may be programmed to perform a z-plane scan to identify topographic areas of interest above a certain height threshold and then calculate the area of the total surface covered by said areas of interest. One skilled in the art would readily understand that the less area covered by said areas of interest post-cleaning, the more efficacious the cleaning composition. Preferably, at least 75% of the residue/contaminants are removed from the microelectronic device using the compositions described herein, more preferably at least 90%, even more preferably at least 95%, and most preferably at least 99% of the residue/contaminants are removed.

Compositions described herein may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In one aspect, a cleaning composition is described, said cleaning composition comprising, consisting of, or consisting essentially of at least one quaternary base, at least one amine, at least one corrosion inhibitor, and at least one solvent (e.g., water). In one embodiment, the cleaning composition comprises, consists of, or consists essentially of at least one quaternary base, at least two amines, at least one corrosion inhibitor, and at least one solvent (e.g., water). In another embodiment, the cleaning composition comprises, consists of, or consists essentially of at least one quaternary base, at least two amines, at least two corrosion inhibitors, and at least one solvent (e.g., water). The cleaning composition is particularly useful for cleaning residue and contaminants, e.g., post-CMP residue, post-etch residue, post-ash residue, and contaminants from a microelectronic device structure without damaging the interconnect metals (e.g., copper), barrier layers (e.g., ruthenium), and low-k dielectric materials. In one embodiment, the microelectronic device comprises cobalt. In another embodiment, the microelectronic device comprises ruthenium. In yet another embodiment, the microelectronic device comprises manganese. Regardless of the embodiment, the cleaning compositions are preferably substantially devoid of oxidizing agents; fluoride-containing sources; abrasive materials; gallic acid; alkali and/or alkaline earth metal bases; organic solvents; and combinations thereof, prior to removal of residue material from the microelectronic device. In addition, the cleaning compositions should not solidify to form a polymeric solid, for example, photoresist.

The corrosion inhibitors include, but are not limited to, ascorbic acid, L(+)-ascorbic acid, isoascorbic acid, ascorbic acid derivatives, benzotriazole, citric acid, ethylenediamine, oxalic acid, tannic acid, glycine, histidine, 1,2,4-triazole (TAZ), tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1,2,3-triazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 2-mercaptobenzimidazole (MBI), 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 5-phenyltetrazole, 1,3-dimethyl-2-imidazolidinone, 1,5-pentamethylenetetrazole, 1-phenyl-5-mercaptotetrazole, diaminomethyltriazine, imidazoline thione, mercaptobenzimidazole, 4-methyl-4H-1,2,4-triazole-3-thiol, benzothiazole, tritolyl phosphate, imidazole, indiazole, pyrazole, pyrazole derivatives, 4-methylpyrazole, 2-amino-thiazole, 2-amino-1,3,4-thiadiazole, pterine, pyrimidine, pyrazine, cytosine, pyridazine, 1H-pyrazole-3-carboxylic acid, 1H-pyrazole-4-carboxylic acid, 3-amino-5-hydroxy-1H-pyrazole, 3-amino-5-methyl-1H-pyrazole, phosphoric acid, phosphoric acid derivatives (such as esters of phosphoric acid such as phosphoric acid tributyl ester; phosphoric acid triethyl ester; phosphoric acid, tris(2-ethylhexyl) ester; phosphoric acid, monomethyl ester; Phosphoric acid, isotridecyl ester; phosphoric acid, 2-ethylhexyl diphenyl ester; and phosphoric acid triphenyl ester), benzoic acid, ammonium benzoate, catechol, pyrogallol, resorcinol, hydroquinone, cyanuric acid, barbituric acid and derivatives such as 1,2-dimethylbarbituric acid, alpha-keto acids such as pyruvic acid, phosphonic acid and derivatives thereof such as 1-hydroxyethylidene-1,1-diphosphonic acid (HEDP), propanethiol, benzohydroxamic acids, heterocyclic nitrogen inhibitors, potassium ethylxanthate, and combinations thereof. Alternatively, or in addition to, the corrosion inhibitors include: ribosylpurines such as N-ribosylpurine, adenosine, guanosine, 2-aminopurine riboside, 2-methoxyadenosine, and methylated or deoxy derivatives thereof, such as N-methyladenosine (C₁₁H₁₅N₅O₄), N,N-dimethyladenosine (C₁₂H₁₇N₅O₄) trimethylated adenosine (C₁₃H₁₉N₅O₄), trimethyl N-methyladenosine (C₁₄H₂₁N₅O₄), C-4′-methyladenosine, and 3-deoxyadenosine; degradation products of adenosine and adenosine derivatives including, but not limited to, adenine (C₅H₅N₅), methylated adenine (e.g., N-methyl-7H-purin-6-amine, C₆H₇N₅), dimethylated adenine (e.g., N,N-dimethyl-7H-purin-6-amine, C₇H₉N₅), N4,N4-dimethylpyrimidine-4,5,6-triamine (C₆H₁₁N₅), 4,5,6-triaminopyrimidine, allantoin (C₄H₆N₄O₃), hydroxylated C—O—O—C dimers ((C₅H₄N₅O₂)₂), C—C bridged dimers ((C₅H₄N₅)₂ or (C₅H₄N₅O)₂), ribose (C₅H₁₀O₅), methylated ribose (e.g., 5-(methoxymethyl)tetrahydrofuran-2,3,4-triol, C₆H₁₂O₅), tetramethylated ribose (e.g., 2,3,4-trimethoxy-5-(methoxymethyl)tetrahydrofuran, C₉H₁₈O₅), and other ribose derivatives such as methylated hydrolyzed diribose compounds; purine-saccharide complexes including, but not limited to, xylose, glucose, etc.; other purine compounds such as purine, guanine, hypoxanthine, xanthine, theobromine, caffeine, uric acid, and isoguanine, and methylated or deoxy derivatives thereof; triaminopyrimidine and other substituted pyrimidines such as amino-substituted pyrimidines; dimers, trimers or polymers of any of the compounds, reaction or degradation products, or derivatives thereof; and combinations thereof. In one embodiment, the corrosion inhibitor comprises one of pyrazole, 4-methylpyrazole, 1H-pyrazole-3-carboxylic acid, 1H-pyrazole-4-carboxylic acid, 3-amino-5-hydroxy-1H-pyrazole, and 3-amino-5-methyl-1H-pyrazole. In a preferred embodiment, the cleaning compositions comprise pyrazole, 1H-pyrazole-3-carboxylic acid, 1H-pyrazole-4-carboxylic acid, 3-amino-5-hydroxy-1H-pyrazole, 3-amino-5-methyl-1H-pyrazole, phosphoric acid, phosphoric acid derivatives, adenosine, a combination of phosphoric acid and pyrazole or pyrazole derivative, a combination of ascorbic acid and adenosine, a combination of adenosine and phosphoric acid, or a combination of adenosine and pyrazole or pyrazole derivative. Most preferably, the corrosion inhibitor comprises pyrazole.

Illustrative amines that may be useful in specific compositions include species having the general formula NR¹R²R³, wherein R¹, R² and R³ may be the same as or different from one another and are selected from the group consisting of hydrogen, straight-chained or branched C₁-C₆ alkyl (e.g., methyl, ethyl, propyl, butyl, pentyl, and hexyl), straight-chained or branched C₁-C₆ alcohol (e.g., methanol, ethanol, propanol, butanol, pentanol, and hexanol), and straight chained or branched ethers having the formula R⁴—O—R⁵, where R⁴ and R⁵ may be the same as or different from one another and are selected from the group consisting of C₁-C₆ alkyls as defined above. Most preferably, at least one of R¹, R² and R³ is a straight-chained or branched C₁-C₆ alcohol. Examples include, without limitation, alkanolamines such as aminoethylethanolamine, N-methylaminoethanol, aminoethoxyethanol, dimethylaminoethoxyethanol, diethanolamine, N-methyldiethanolamine, monoethanolamine (MEA), triethanolamine (TEA), 1-amino-2-propanol, 2-amino-1-butanol, isobutanolamine, triethylenediamine, other C₁-C₈ alkanolamines and combinations thereof. Alternatively, or in addition to the NR¹R²R³ amine, the amine may be a multi-functional amine including, but not limited to, tetraethylenepentamine (TEPA), 4-(2-hydroxyethyl)morpholine (HEM), N-aminoethylpiperazine (N-AEP), ethylenediaminetetraacetic acid (EDTA), 1,2-cyclohexanediamine-N,N,N′,N′-tetraacetic acid (CDTA), iminodiacetic acid (IDA), 2-(hydroxyethyl)iminodiacetic acid (HIDA), nitrilotriacetic acid, and combinations thereof. Other amines contemplated include the amine-N-oxides such as trimethylamine-N-oxide (TMAO). Preferably, the amines include at least one species selected from the group consisting of monoethanolamine, triethanolamine, EDTA, CDTA, HIDA, N-AEP, and combinations thereof. Preferably, the amines comprise MEA, TEA, or a combination of MEA and TEA.

Quaternary bases contemplated herein include compounds having the formula NR¹R²R³R⁴OH, wherein R¹, R², R³ and R⁴ may be the same as or different from one another and are selected from the group consisting of hydrogen, straight-chained or branched C₁-C₆ alkyl (e.g., methyl, ethyl, propyl, butyl, pentyl, and hexyl), and substituted or unsubstituted C₆-C₁₀ aryl, e.g., benzyl. Tetraalkylammonium hydroxides that are commercially available include tetraethylammonium hydroxide (TEAH), tetramethyammonium hydroxide (TMAH), tetrapropylammonium hydroxide (TPAH), tetrabutylammonium hydroxide (TBAH), tributylmethylammonium hydroxide (TBMAH), benzyltrimethylammonium hydroxide (BTMAH), and combinations thereof, may be used. Tetraalkylammonium hydroxides which are not commercially available may be prepared in a manner analogous to the published synthetic methods used to prepare TMAH, TEAH, TPAH, TBAH, TBMAH, and BTMAH, which are known to one ordinary of skill in the art. Another widely used quaternary ammonium base is choline hydroxide. Preferably, the quaternary base comprises TMAH or TEAH.

The pH of the cleaning compositions described herein is greater than 7, preferably in a range from about 10 to greater than 14, more preferably in a range from about 12 to about 14. In a preferred embodiment, the pH of the concentrated cleaning composition is greater than 13.

In a particularly preferred embodiment, the cleaning composition comprises, consists of, or consists essentially of at least one quaternary base, at least one amine, pyrazole or a derivative thereof, and water. In another particularly preferred embodiment, the cleaning composition comprises, consists of, or consists essentially of at least one quaternary base, at least two amines, pyrazole or a derivative thereof, and water. Alternatively, the cleaning composition can comprise, consist of or consist essentially of at least one quaternary base, at least two amines, phosphoric acid, pyrazole or a derivative thereof, and water. In still another alternative, the cleaning composition can comprise, consist of or consist essentially of at least one quaternary base, at least two amines, ascorbic acid, pyrazole or a derivative thereof, and water. In a particularly preferred embodiment, the cleaning composition comprises, consists of, or consists essentially of at least one quaternary base, TEA, pyrazole or a derivative thereof, and water. In another particularly preferred embodiment, the cleaning composition comprises, consists of, or consists essentially of at least one quaternary base, MEA, TEA, pyrazole or a derivative thereof, and water, wherein the weight percent of TEA is equal to or greater than the weight percent of MEA. In each case, the composition is substantially devoid of oxidizing agents; fluoride-containing sources; abrasive materials; gallic acid; alkali and/or alkaline earth metal bases; organic solvents; and combinations thereof, prior to removal of residue material from the microelectronic device. In addition, the cleaning compositions should not solidify to form a polymeric solid, for example, photoresist.

With regards to compositional amounts, the weight percent ratios of each component is preferably as follows: about 0.1:1 to about 50:1 quaternary base to corrosion inhibitor, preferably about 1:1 to about 20:1; and about 0.1:1 to about 100:1 organic amine to corrosion inhibitor, preferably about 1:1 to about 20:1. When the cleaning compositions include both MEA and TEA, preferably the weight percent ratios of TEA to MEA is about 0.1:1 to about 30:1, preferably about 1:1 to about 20:1, and most preferably about 5:1 to about 10:1.

The range of weight percent ratios of the components will cover all possible concentrated or diluted embodiments of the composition. Towards that end, in one embodiment, a concentrated cleaning composition is provided that can be diluted for use as a cleaning solution. A concentrated composition, or “concentrate,” advantageously permits a user, e.g. CMP process engineer, to dilute the concentrate to the desired strength and pH at the point of use. Dilution of the concentrated cleaning composition may be in a range from about 1:1 to about 2500:1, preferably about 5:1 to about 200:1, and most preferably about 30:1 to about 70:1, wherein the cleaning composition is diluted at or just before the tool with solvent, e.g., deionized water. It is to be appreciated by one skilled in the art that following dilution, the range of weight percent ratios of the components disclosed herein should remain unchanged.

The compositions described herein may have utility in applications including, but not limited to, post-etch residue removal, post-ash residue removal surface preparation, post-plating cleaning and post-CMP residue removal. In addition, it is contemplated that the cleaning compositions described herein may be useful for the cleaning and protection of other metal products including, but not limited to, decorative metals, metal wire bonding, printed circuit boards and other electronic packaging using metal or metal alloys. Advantageously, the cleaning compositions are compatible with the materials on the microelectronic device such as conductive metals, low-k dielectrics, and barrier layer materials (e.g., those comprising cobalt). Moreover, the cleaning compositions minimize water marks left on ultra low-k dielectric materials subsequent to post-CMP cleaning.

In yet another preferred embodiment, the cleaning compositions described herein further include residue and/or contaminants. The residue and contaminants may be dissolved and/or suspended in the compositions. Preferably, the residue includes post-CMP residue, post-etch residue, post-ash residue, contaminants, or combinations thereof.

The cleaning compositions are easily formulated by simple addition of the respective ingredients and mixing to homogeneous condition. Furthermore, the compositions may be readily formulated as single-package formulations or multi-part formulations that are mixed at or before the point of use, e.g., the individual parts of the multi-part formulation may be mixed at the tool or in a storage tank upstream of the tool. The concentrations of the respective ingredients may be widely varied in specific multiples of the composition, i.e., more dilute or more concentrated, and it will be appreciated that the compositions described herein can variously and alternatively comprise, consist or consist essentially of any combination of ingredients consistent with the disclosure herein.

Accordingly, another aspect relates to a kit including, in one or more containers, one or more components adapted to form the compositions described herein. The kit may include, in one or more containers, at least one quaternary base, at least one amine, at least one corrosion inhibitor, and at least one solvent, for combining with additional solvent, e.g., water, at the fab or the point of use. The containers of the kit must be suitable for storing and shipping said cleaning compositions, for example, NOWPak® containers (Advanced Technology Materials, Inc., Danbury, Conn., USA).

The one or more containers which contain the components of the cleaning composition preferably include means for bringing the components in said one or more containers in fluid communication for blending and dispense. For example, referring to the NOWPak® containers, gas pressure may be applied to the outside of a liner in said one or more containers to cause at least a portion of the contents of the liner to be discharged and hence enable fluid communication for blending and dispense. Alternatively, gas pressure may be applied to the head space of a conventional pressurizable container or a pump may be used to enable fluid communication. In addition, the system preferably includes a dispensing port for dispensing the blended cleaning composition to a process tool.

Substantially chemically inert, impurity-free, flexible and resilient polymeric film materials, such as high density polyethylene, are preferably used to fabricate the liners for said one or more containers. Desirable liner materials are processed without requiring co-extrusion or barrier layers, and without any pigments, UV inhibitors, or processing agents that may adversely affect the purity requirements for components to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Regarding the containers for the kits, the disclosures of the following patents and patent applications are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” U.S. Pat. No. 6,698,619 entitled “RETURNABLE AND REUSABLE, BAG-IN-DRUM FLUID STORAGE AND DISPENSING CONTAINER SYSTEM;” and PCT/US08/63276 entitled “SYSTEMS AND METHODS FOR MATERIAL BLENDING AND DISTRIBUTION” filed on May 9, 2008 in the name of Advanced Technology Materials, Inc.

As applied to microelectronic manufacturing operations, the cleaning compositions described herein are usefully employed to clean post-CMP residue and/or contaminants, e.g., BTA, from the surface of the microelectronic device. The cleaning compositions do not damage low-k dielectric materials or corrode metal interconnects, e.g., copper, on the device surface. Moreover, the cleaning compositions are compatible with barrier layer materials including tantalum (Ta), tantalum nitride (TaNₓ), titanium (Ti), titanium nitride (TiN), ruthenium (Ru), cobalt (Co), manganese (Mn), molybdenum (Mo), rhenium (Rh), and alloys thereof. Further, the cleaning compositions minimize the water marks left on the ultra low-k dielectric materials present on the microelectronic device surface. Preferably the cleaning compositions remove at least 85% of the residue and contaminants present on the device prior to residue removal, more preferably at least 90%, even more preferably at least 95%, and most preferably at least 99%.

In post-CMP residue and contaminant cleaning application, the cleaning composition may be used with a large variety of conventional cleaning tools such as megasonics and brush scrubbing, including, but not limited to, Verteq single wafer megasonic Goldfinger, OnTrak systems DDS (double-sided scrubbers), SEZ or other single wafer spray rinse, Applied Materials Mirra-Mesa™/Reflexion™/Reflexion LK™, and Megasonic batch wet bench systems.

In another aspect, a method of using of the compositions described herein for cleaning post-CMP residue, post-etch residue, post-ash residue and/or contaminants from microelectronic devices having same thereon is described, wherein the cleaning composition typically is contacted with the device for a time of from about 5 sec to about 30 minutes, preferably about 1 sec to 20 min, preferably about 15 sec to about 5 min at temperature in a range of from about 20° C. to about 90° C., preferably about 20° C. to about 50° C. Such contacting times and temperatures are illustrative, and any other suitable time and temperature conditions may be employed that are efficacious to at least partially clean the post-CMP residue/contaminants from the device, within the broad practice of the method. “At least partially clean” and “substantial removal” both correspond to at removal of at least 85% of the residue/contaminants present on the device prior to residue removal, more preferably at least 90%, even more preferably at least 95%, and most preferred at least 99%.

Following the achievement of the desired cleaning action, the cleaning composition may be readily removed from the device to which it has previously been applied, as may be desired and efficacious in a given end use application of the compositions described herein. Preferably, the rinse solution includes deionized water. Thereafter, the device may be dried using nitrogen or a spin-dry cycle.

Yet another aspect relates to the improved microelectronic devices made according to the methods described herein and to products containing such microelectronic devices. Preferably, the microelectronic device comprises ruthenium.

Another aspect relates to a recycled cleaning composition, wherein the cleaning composition may be recycled until residue and/or contaminant loading reaches the maximum amount the cleaning composition may accommodate, as readily determined by one skilled in the art.

A still further aspect relates to methods of manufacturing an article comprising a microelectronic device, said method comprising contacting the microelectronic device with a cleaning composition for sufficient time to clean post-CMP residue and contaminants from the microelectronic device having said residue and contaminants thereon, and incorporating said microelectronic device into said article, using a cleaning composition described herein. Preferably, the microelectronic device comprises a ruthenium barrier layer as described herein to prevent diffusion of copper into low-k dielectric materials.

In another aspect, a method of removing post-CMP residue and contaminants from a microelectronic device having same thereon is described, said method comprising:
polishing the microelectronic device with a CMP slurry;
contacting the microelectronic device with a cleaning composition comprising at least one quaternary base, at least one amine, at least one corrosion inhibitor, and at least one solvent for a sufficient time to remove post-CMP residue and contaminants from the microelectronic device to form a post-CMP residue-containing composition; and
continuously contacting the microelectronic device with the post-CMP residue-containing composition for a sufficient amount of time to effect substantial cleaning of the microelectronic device.

Another aspect relates to an article of manufacture comprising a cleaning composition, a microelectronic device wafer, and material selected from the group consisting of residue, contaminants and combinations thereof, wherein the cleaning composition comprises at least one quaternary base, at least one amine, at least one corrosion inhibitor, and at least one solvent, wherein the residue comprises at least one of post-CMP residue, post-etch residue and post-ash residue.

Still another aspect relates to the manufacture of a microelectronic device, said method comprising:
etching a pattern into a low-k dielectric material;
depositing a substantially isotropic barrier layer onto the etched low-k dielectric material;
depositing a metal conductive layer onto the barrier layer;
chemical mechanical polishing the microelectronic device with a CMP slurry to remove the metal conductive layer and the barrier layer to expose the low-k dielectric material; and
contacting the microelectronic device with a cleaning composition comprising at least one quaternary base, at least one amine, at least one corrosion inhibitor, and at least one solvent for a sufficient time to remove post-CMP residue and contaminants from the microelectronic device to form a post-CMP residue-containing composition,
wherein the barrier layer comprises a species selected from the group consisting of tantalum (Ta), tantalum nitride (TaNₓ), titanium (Ti), titanium nitride (TiN), ruthenium (Ru), cobalt (Co), manganese (Mn), molybdenum (Mo), rhenium (Rh), and alloys thereof.

Another aspect relates to a composition for cleaning residue and contaminants, e.g., post-CMP residue, post-etch residue, post-ash residue, from a microelectronic device structure without damaging the interconnect metals (e.g., copper), barrier layers (e.g., ruthenium), and low-k dielectric materials, wherein the composition consists of at least one quaternary base, at least one corrosion inhibitor, and at least one solvent. The species of quaternary bases, corrosion inhibitors and solvents are disclosed herein. Notably, the composition of this aspect is devoid of alkanolamines and hydroxylamines.

The features and advantages are more fully shown by the illustrative examples discussed below.

### EXAMPLE 1

The following solutions were prepared as shown in Table 1. The remaining component was deionized water.

TABLE 1

| | quaternary | | | Ascorbic | | | |
|---|---|---|---|---|---|---|---|
| | base | MEA | Adenosine | acid | H₃PO₄ | TEA | Pyrazole |
| Formulation | (wt %) | (wt %) | (wt %) | (wt %) | (wt %) | (wt %) | (wt %) |
| 1 | 5 | | 0.3 | | | 4.5 | |
| 2 | 5 | 0.5 | 0.1 | | | 4 | |
| 3 | 7.5 | 0.5 | 0.1 | | 3 | 4 | |
| 4 | 5 | 0.5 | 0.3 | 3 | | 4 | |
| 5 | 1-8 | | | | | 2-8 | 0.1-1 |
| 6 | 1-8 | 0.01-1 | | 1-6 | | 2-8 | 0.1-1 |
| 7 | 1-8 | 0.01-1 | | | | 2-8 | 0.1-1 |
| 8 | 1-8 | 0.01-1 | | | 1-6 | 2-8 | 0.1-1 |
| 9 | 1-8 | 2-8 | | 1-6 | | | 0.1-1 |
| 10 | 1-8 | 2-8 | | 1-6 | | | 0.1-1 |
| 11 | 1-8 | | 0.01-0.3 | | | | |

Each formulation was diluted 60:1 with water and a coupon comprising BTA residue and a coupon consisting of copper metal were immersed in each solution for 30 minutes at 25° C. and 400 rpm. Following immersion, each coupon was rinsed for 30 seconds with water. The BTA removal of formulations 1-4, relative to DI water, are shown in Table 2 below.

TABLE 2

| | BTA removal ability |
|---|---|
| Formulation | relative to DI water |
| 1 | 115.155 |
| 2 | 127.281 |
| 3 | 114.969 |
| 4 | 105.855 |
| DI water | 100 |

In terms of copper etch rates, formulations 1-11 in Table 1 all had copper etch rates less than or equal to about 1 Å/min. In terms of BTA removal, formulations 1-11 in Table 1 all removed BTA in amounts greater than or equal to that of deionized water.

### EXAMPLE 2

Formulations A-K were prepared, wherein the remaining component was DI water

| | TMAH | | corrosion inhibitor 1 | corrosion inhibitor 2 |
|---|---|---|---|---|
| Formulation | (wt %) | amine (wt %) | (wt %) | (wt %) |
| A | 5 | 4.5 wt % MEA | | |
| B | 5 | 4.5 wt % MEA | 0.1 wt % histidine | 0.3 wt % adenosine |
| C | 5 | 4.5 wt % MEA | 0.1 wt % glycine | 0.2 wt % adenosine |
| D | 5 | 4.5 wt % TEA | 0.3 wt % adenosine | |
| E | 5 | 4.5 wt % TEA | 0.3 wt % 5-phenyl | |
| | | | tetrazole | |
| F | 5 | 4.5 wt % TMAO | 0.3 wt % adenosine | |
| G | 5 | 4.5 wt % TEA | 0.3 wt % pyrazole | |
| H | 5 | 4.5 wt % MEA | 0.5 wt % adenosine | 5 wt % ascorbic acid |
| I | 5 | 4.5 wt % TEA | 0.5 wt % adenosine | 5 wt % H₃PO₄ |
| J | 5 | 4.5 wt % TMAO | 0.5 wt % adenosine | 5 wt % H₃PO₄ |
| K (baseline) | 5 | 4.5 wt % MEA | 0.1 wt % benzotriazole | |

Each formulation was diluted 60:1 with water and a copper coupon was immersed in each solution for 30 minutes at 25° C. and 400 rpm. Following immersion, each coupon was rinsed for 30 seconds with water. The copper etch rate for each formulation was determined and compiled in the following table.

| Formulation | Cu etch rate (Å min⁻¹) |
|---|---|
| A | 3.113 |
| B | 2.308 |
| C | 2.953 |
| D | 0.573 |
| E | 1.127 |
| F | 0.391 |
| G | 0.608 |
| H | 0.402 |
| I | 0.523 |
| J | 0.342 |
| K | 0.362 |

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. A method of removing residue and contaminants from a microelectronic device having said residue and contaminants thereon, said method comprising contacting the microelectronic device with a cleaning composition for sufficient time to at least partially clean said residue and contaminants from the microelectronic device, wherein the cleaning composition includes at least one quaternary base, at least one amine, at least one corrosion inhibitor, and at least one solvent, wherein the microelectronic device comprises exposed barrier layer that reduces diffusion of copper into low-k dielectric materials.

2. (canceled)

3. The method of claim 1, wherein the residue is selected from the group consisting of post-CMP residue, post-etch residue, and post-ash residue.

4. The method of claim 1, wherein the cleaning compositions are substantially devoid of oxidizing agents; fluoride-containing sources; abrasive materials; gallic acid; alkali and/or alkaline earth metal bases; organic solvents; and combinations thereof, prior to removal of residue material from the microelectronic device.

5. The method of claim 1, wherein the at least one corrosion inhibitor comprises pyrazole, pyrazole derivatives, phosphoric acid, phosphoric acid derivatives, ascorbic acid, adenosine, adenosine derivatives, and combinations thereof.

6. The method of claim 1, wherein the at least one corrosion inhibitor comprises pyrazole or pyrazole derivatives.

7. The method of claim 1, wherein the at least one amine comprises a species selected from the group consisting of aminoethylethanolamine, N-methylaminoethanol, aminoethoxyethanol, dimethylaminoethoxyethanol, diethanolamine, N-methyldiethanolamine, monoethanolamine, triethanolamine, 1-amino-2-propanol, 2-amino-1-butanol, isobutanolamine, triethylenediamine, tetraethylenepentamine (TEPA), 4-(2-hydroxyethyl)morpholine (HEM), N-aminoethylpiperazine (N-AEP), ethylenediaminetetraacetic acid (EDTA), 1,2-cyclohexanediamine-N,N,N′,N′-tetraacetic acid (CDTA), iminodiacetic acid (IDA), 2-(hydroxyethyl)iminodiacetic acid (HIDA), nitrilotriacetic acid, trimethylamine-N-oxide, and combinations thereof.

8. The method of claim 1, wherein the at least one amine comprises monoethanolamine, triethanolamine, or a combination of monoethanolamine and triethanolamine.

9. The method of claim 1, wherein the at least one quaternary base comprises a species selected from the group consisting of tetraethylammonium hydroxide (TEAH), tetramethyammonium hydroxide (TMAH), tetrapropylammonium hydroxide (TPAH), tetrabutylammonium hydroxide (TBAH), tributylmethylammonium hydroxide (TBMAH), benzyltrimethylammonium hydroxide (BTMAH), choline hydroxide, and combinations thereof.

10. The method of claim 1, wherein the at least one quaternary base comprises TMAH.

11. The method of claim 1, wherein the at least one solvent comprises water.

12. The method of claim 1, wherein the pH of the cleaning compositions are in a range from about 10 to greater than 14.

13. The method of claim 1, comprising at least one quaternary base, triethanolamine, pyrazole, and water.

14. The method of claim 1, wherein the exposed barrier layer comprises cobalt, ruthenium, or manganese.

15. (canceled)

16. (canceled)

17. The method of claim 1, further comprising diluting the cleaning composition with solvent at or before a point of use, wherein said solvent comprises water.

18. (canceled)

19. The method of claim 1, wherein the microelectronic device comprises copper-containing material.

20. The method of claim 1, further comprising rinsing the microelectronic device with deionized water following contact with the cleaning composition.

21. A method of manufacturing a microelectronic device, said method comprising:
etching a pattern into a low-k dielectric material;
depositing a substantially isotropic barrier layer onto the etched low-k dielectric material;
depositing a metal conductive layer onto the barrier layer;
chemical mechanical polishing the microelectronic device with a CMP slurry to remove the metal conductive layer and the barrier layer to expose the low-k dielectric material; and
contacting the microelectronic device with a cleaning composition comprising at least one quaternary base, at least one amine, at least one corrosion inhibitor, and at least one solvent for a sufficient time to remove post-CMP residue and contaminants from the microelectronic device to form a post-CMP residue-containing composition,
wherein the barrier layer comprises a species selected from the group consisting of tantalum (Ta), tantalum nitride (TaNₓ), titanium (Ti), titanium nitride (TiN), ruthenium (Ru), cobalt (Co), manganese (Mn), molybdenum (Mo), rhenium (Rh), and alloys thereof.

22. A cleaning composition comprising at least one quaternary base, at least one amine, at least one corrosion inhibitor, and at least one solvent, wherein the at least one corrosion inhibitor comprises pyrazole, pyrazole derivatives, phosphoric acid, phosphoric acid derivatives, ascorbic acid, adenosine, adenosine derivatives, and combinations thereof.

23. (canceled)

24. (canceled)

25. (canceled)

26. The cleaning composition of claim 22, wherein the microelectronic device comprises exposed cobalt or ruthenium.

27. A composition for cleaning residue and contaminants from a microelectronic device structure without damaging the interconnect metals, barrier layers, and low-k dielectric materials, said composition comprising at least one quaternary base, at least one corrosion inhibitor, and at least one solvent, wherein the composition is substantially devoid of alkanolamines and hydroxylamines.
